(19) United States
(12) Patent Application Publication
(10) Pub. No.: US 2007/0026142 A1
(43) Pub. Date: Feb. 1, 2007

(54) One-step process for rapid structure repair

(76) Inventors: Rina Singh, Westerville, OH (US); Robert B. Fechter, Worthington, OH (US)

Correspondence Address: Ashland Licensing and Intellectual Property LLC, 5200 Blazer Parkway, Dublin, OH, 43017, US

(21) Appl. No.: 11/492,696

(22) Filed: Jul. 25, 2006

Related U.S. Application Data
(60) Provisional application No. 60/702,933, filed on Jul. 27, 2005.

(51) Int. Cl. B05D 3/00

(52) U.S. Cl. 427/140

(57) ABSTRACT

This invention relates to a one-step process for rapidly repairing structures. The process uses a binder comprising a polyisocyanate-terminated pre-polymer containing a divalent metal catalyst, an acid chloride retarder, and preferably a tertiary amine catalyst, which cures in the presence of moisture.

### CLAIM TO PRIORITY AND CROSS REFERENCE

This application claims the benefit of U.S. provisional application No. 60/702,933, filed on Jul. 27, 2005 and entitled One-Step Process for Rapid Structure Repair, the contents of which are hereby incorporated into this application.

### TECHNICAL FIELD

This invention relates to a one-step process for rapidly repairing structures. The process uses a binder comprising a polyisocyanate-terminated pre-polymer containing a divalent metal catalyst, an acid chloride retarder, and preferably a tertiary amine catalyst, which cures in the presence of moisture.

### BACKGROUND

The Air Force and other services have critical needs for technology for the rapid construction, repair, and safe operation of airbases. One of the problems involved in carrying out such activities is the presence of moisture in or around the structure to be repaired.

Typically, solvent-based binders, usually as two-component binders, are used in bonding aggregates. These binders are typically based on phenolic-urethane chemistry. Most commonly, such binders contain a large amount of solvents, usually 40, to 50 weight percent. The solvents are usually aromatic hydrocarbons, such as toluene, xylene, and others. For instance, see U.S. Pat. Nos. 6,130,268 and 5,872,203, and DE 29,920,721.

Another requirement needed for such applications is sufficient work time, so that setting of binder/aggregate mixture does not result before the structure to be filled is completely filled with the binder/aggregate mixture. Not only is an adequate work time needed to adequately fill the structure, but very short work time causes the moisture-cured binder/aggregate to rapidly setup in the mixing equipment. A work time of 15 to 30 minutes is typically required to fill large holes (about 5 feet deep and 10 feet wide).

All citations referred to in this application are expressly incorporated by reference.

### BRIEF DESCRIPTION OF THE DRAWINGS

FIG. 1 shows that effect of using MPCP on work time.

FIG. 2 shows the effect of using MPCP on work time on core hardness.

### SUMMARY

This invention relates to a one-step process for rapidly repairing structures. The process uses a binder comprising a polyisocyanate-terminated pre-polymer containing a divalent metal catalyst, an acid chloride retarder, and preferably a tertiary amine catalyst, which cures in the presence of moisture.

The process is particularly useful for rapid construction and repair, e.g. airfield damage repair applications, crater repair, pothole repair, bridge repair, road repair, and ramp repair. Although the binders used in the process can be used neat, they are typically mixed with aggregate or indigenous materials available at the site where the repair is needed. The binders used in the process have good shelf stability and excellent bonding strength to aggregates in presence of moisture.

The structures formed by carrying out the process have excellent water resistance, flexural strength, and compressive strength. These binders used in the one-step process cure rapidly in presence of moisture, e.g. water, atmospheric moisture. Additionally, the binder used is preferably solvent-free. And because the process only involves one step, the process can be carried out with simplicity and minimal labor cost.

The binders used in the process provide advantages over other polyurethane binders because they cure in the presence of high levels of water without degradation of strength properties. It is known that most polyurethane systems tend to lose mechanical performance in presence of moisture.

The addition of the acid chloride retarder increases the work time of the binder, so that setting of binder/aggregate mixture does not occur before the structure to be filled is completely filled with the binder/aggregate mixture, and so that binder/aggregate mixture does not setup in the mixing equipment. A work time of 15 to 30 minutes is typically required to fill large holes (about 5 feet deep and 10 feet wide).

### DETAILED DESCRIPTION

The polyisocyanate pre-polymers used in the process are the reaction products of an excess of organic polyisocyanate and an active hydrogen-containing compound. Although primary and secondary amines can be used as the active hydrogen-containing compound to prepare the pre-polymer, preferably the active hydrogen-containing compound is a compound having hydroxyl group with a functionality of at least 2.0. The pre-polymers are prepared by methods well known to those of ordinary skill in the art. The amount of free isocyanate in the polyisocyanate pre-polymer typically ranges from 1 to 30, preferably from 9 to 18, and most preferably from 12 to 14 percent free NCO content. A tertiary amine catalyst is preferably added to the pre-polymers to promote their reaction with moisture.

The polyisocyanate pre-polymer is prepared by reacting the organic polyisocyanate with typically from 1 to 50 weight percent, preferably from 35 to 48 weight percent, of a compound having active hydrogen-containing groups, preferably free hydroxyl groups, where said weight percent is based upon the weight percent of the organic polyisocyanate. Typical compounds having free hydroxyl groups include polyhydric alcohols (e.g. glycols), phenolic resole resins, polyolefin polyols, polycarbonate polyols, polyester polyols, polyether polyols, and mixtures thereof.

The general procedure for preparing the polyisocyanate pre-polymer involves heating the hydroxyl-containing compound in the presence of the organic polyisocyanate until all of the active hydrogen-containing groups have reacted in the presence of a divalent metal catalyst. Examples of divalent metal catalysts include compounds having a divalent metal ion such as zinc, lead, manganese, copper, tin, magnesium, cobalt, calcium, or barium. Specific examples include dibutyltindilaurate stannous octoate, dibutyltin diacetate, and stannous oleate. Particularly useful is dibutyltindilaurate. The divalent metal catalyst is typically added to the pre-polymer in an amount of from 0.01% to 1.0% by weight of the pre-polymer, preferably about in a range between 0.01 to 0.5%. The mixture is typically heated to a temperature of about 50° C. for about two hours. The divalent metal catalyst remains in the formed pre-polymer.

The acid chloride retarder used is selected from the group consisting of acid chlorides and mixtures thereof. Examples of such retarders include benzoyl chloride, benzene phosphorus oxydichloride, phosphorus oxychloride, phthaloyl chloride, and monophenyldichlorophosphate. The amount of acid chloride retarder used in the process is typically from 0.01 to 1.0 weight percent based upon the weight of the binder, preferably from 0.01 to 0.5 weight percent, and most preferably from 0.01 to 0.3 weight percent.

The tertiary amine catalysts are liquid tertiary amines. Examples include 4-alkyl pyridines wherein the alkyl group has from one to four carbon atoms, isoquinoline, arylpyridines such as phenyl pyridine, pyridine, acridine, 2-methoxypyridine, pyridazine, 3-chloro pyridine, quinoline, N-methyl imidazole, N-ethyl imidazole, 4,4′-dipyridine, 4-phenylpropylpyridine, 1-methylbenzimidazole, and 1,4-thiazine. Preferably used as the liquid tertiary amine catalyst is an aliphatic tertiary amine, particularly [tris (3-dimethylamino) propylamine]. Preferably used as the tertiary amine are 2,2′-dimorpholinodiethylether and N,N′-dimethylpiperazine.

The amount of tertiary amine catalyst used is typically from 0.01 to 1.0 parts by weight, preferably from 0.01 to 0.5 parts by weight, most preferably from 0.1 to 0.25 parts by weight.

The organic polyisocyanate used to prepare the organic polyisocyanate pre-polymer is an organic polyisocyanate having a functionality of two or more, preferably 2 to 5. It may be aliphatic, cycloaliphatic, aromatic, or a hybrid polyisocyanate. Mixtures of such polyisocyanates may be used. Representative examples of organic polyisocyanates are aliphatic polyisocyanates such as hexamethylene diisocyanate, alicyclic polyisocyanates such as 4,4′-dicyclohexylmethane diisocyanate, and aromatic polyisocyanates such as 2,4-diphenylmethane diisocyanate and 2,6-toluene diisocyanate, and dimethyl derivatives thereof. Other examples of suitable organic polyisocyanates are 1,5-naphthalene diisocyanate, triphenylmethane triisocyanate, xylylene diisocyanate, and the methyl derivatives thereof, polymethylenepolyphenyl isocyanates, chlorophenylene-2,4-diisocyanate, and the like. The organic polyisocyanate is used in a liquid form. Solid or viscous polyisocyanates must be used in the form of organic solvent solutions, the solvent generally being present in a range of up to 80 percent by weight of the solution.

It may be useful in some cases to blend the pre-polymer with an organic polyisocyanate. If an organic polyisocyanate is blended with the organic polyisocyanate pre-polymer, the amount of organic polyisocyanate blended is from 1 to about 10 percent by weight, based upon the weight of the organic polyisocyanate pre-polymer.

Typical compounds having free hydroxyl groups include polyhydric alcohols (e.g. glycols), phenolic resole resins, polyolefin polyols, polycarbonate polyols, polyester polyols, polyether polyols, and mixtures thereof.

Polyhydric alcohols include ethylene glycol, propylene glycol, diethylene glycol, 1,4-butanediol, neopentyl glycol, 1,6-hexanediol, cyclohexane dimethanol, glycerol, trimethylolpropane, and pentaerythritol.

The polyether polyols are liquid polyether polyols generally having hydroxyl numbers from about 200 to about 1,000, more preferably from 300 to 800, and most preferably from 300 to 600 milligrams of KOH based upon one gram of polyether polyol. The viscosity of the polyether polyol is from 100 to 1,000 centipoise, preferably from 200 to 700 centipoise, most preferably 300 to 500 centipoise. The hydroxyl groups of the polyether polyols are preferably primary and/or secondary hydroxyl groups.

The polyether polyols are prepared by reacting an alkylene oxide with a polyhydric alcohol in the presence of an appropriate catalyst such as sodium methoxide according to methods well known in the art. Representative examples of alkylene oxide include ethylene oxide, propylene oxide, butylene oxide, amylene oxide, styrene oxide, or mixture thereof. The polyhydric alcohols typically used to prepare the polyether polyols generally have a functionality greater than 2.0, preferably from 2.5 to 5.0, most preferably from 2.5 to 4.5. Examples include ethylene glycol, diethylene glycol, propylene glycol, trimethylol propane, glycerin, and pentaerythritol.

Phenolic resins, which can be used as the polyol, include phenolic resole resins, preferably polybenzylic ether phenolic resins. The phenolic resole resin is prepared by reacting an excess of aldehyde with a phenol in the presence of either an alkaline catalyst or a divalent metal catalyst according to methods well known in the art. Solvents, as specified, are also used in the phenolic resin component along with various optional ingredients. The polybenzylic ether phenolic resin is prepared by reacting an excess of aldehyde with a phenol in the presence of a divalent metal catalyst according to methods well known in the art. They preferably contain a preponderance of bridges joining the phenolic nuclei of the polymer which are ortho-ortho benzylic ether bridges. They are prepared by reacting an aldehyde and a phenol in a mole ratio of aldehyde to phenol of at least 1:1, generally from 1.1:1.0 to 3.0:1.0 and preferably from 1.1:1.0 to 2.0:1.0, in the presence of a metal ion catalyst, preferably a divalent metal ion such as zinc, lead, manganese, copper, tin, magnesium, cobalt, calcium, or barium.

Preferably used as the hydroxyl-containing compound to prepare the polyisocyanate pre-polymers are liquid polyester polyols having a hydroxyl number from about 500 to 2,000, preferably from 700 to 1200, and most preferably from 250 to 600; a functionality equal to or greater than 2.0, preferably from 2 to 4; and a viscosity of 500 to 50,000 centipoise at 25° C., preferably 1,000 to 35,000, and most preferably 2,000 to 25,000 centipoise. They are typically prepared by ester interchange of ester and alcohols or glycols by an acidic catalyst. The amount of the polyester polyol in the polyol component is from 2 to 50 weight percent, preferably from 10 to 35 weight percent, most preferably from 10 to 25 weight percent based upon the polyol component.

Preferably used as the polyester polyol are aromatic polyester polyols. These are prepared by the ester interchange of an aromatic polyester such as phthalic anhydride based polyester and polyethylene terephthalate with a polyhydric alcohol such as ethylene glycol, diethylene glycol, triethylene glycol, 1,3,-propanediol, 1,4-butanediol, dipropylene glycol, tripropylene glycol, tetraethylene glycol, glycerin, and mixtures thereof. Examples of commercial available aromatic polyester polyols are Lexorez 1102-60, Lexorez-1640-150, Lexorez Resins manufactured by Inolex Corp.

Conventional defoamers, such as D-1400 (from Dow Corning), may also be added to the binder to promote homogeneous mix and faster reaction during the preparation of the binder.

Any aggregate can be used in connection with the binder. The aggregate may be an aggregate shipped to the site where the space is to be filled or some indigenous material found at the site. Examples of aggregate include sand, zircon, alumina-silicate sand, chromite sand, fly ash, pea gravel, grit, particles of stone, sandstone, clay, crushed concrete, etc. The aggregate is typically used in amounts of 5 to 95 weight percent based upon the total weight of the binder and aggregate.

The process is most simply carried out by adding the neat binder to the space to be filled in an amount to sufficiently fill the space and make it useful for its normal purpose. In some situations, it may be advantageous to add aggregate to the space to be filled and/or the binder before adding the binder to the space to be filled, and in another instance, the aggregate is mixed with the binder and both binder/aggregate are added to fill the space.

The amount of the binder can vary over wide ranges depending upon the specific application. Typically the level of binder ranges from about 5 parts by weight to about 50 parts by weight, preferably from about 25 parts by weight to about 35 parts by weight, where said parts by weight are based upon the parts by weight of the aggregate if an aggregate is used.

Abbreviations
MPCP monophenyldichlorophosphate, a retarder.
PLIODECK® PVC a polyisocyanate pre-polymer, sold commercially by Ashland Specialty Chemical Company, a division of Ashland Inc., having a free NCO content of about 10 to 15 weight percent prepared by reacting an aromatic polyester polyol with MDI, which also contains from about 0.1 to about 1.0 weight percent of a tertiary amine catalyst, which was a mixture comprising a major amount of 2,2′-dimorpholinodiethylether (DMDEE) and a minor amount of N,N′-dimethylpiperazine (DMP), based upon the weight of the polyisocyanate pre-polymer.
ST the time interval between filling the structure to be filled with the binder, or binder/aggregate mixture, and the time when the binder, or binder aggregate mixture, reaches a level of 90 on the Green Hardness “B” Scale Gauge sold by Harry W. Dietert Co., Detroit, Mich.

Work time the time interval after bringing the binder, or the binder/aggregate mixture, into contact with moisture, and the time when the binder, or binder aggregate mixture, reaches a level of 60 on the Green Hardness “B” Scale Gauge sold by Harry W. Dietert Co., Detroit, Mich.

### EXAMPLES

The following examples will illustrate some specific ways to carry out this invention. These examples are merely illustrative and not intended to be exhaustive of all embodiments within the scope of the claims. In the examples, all units are in the metric system and all amounts and percentages are by weight, unless otherwise expressly indicated.

### Example 1

MPCP in increasing amounts was added to 30 grams of PLIODECK® PVC (30 grams), mixed under high shear, and then added to sixty-nine grams of wet Tyndall silica sand having a moisture content ranging from 1 to 2 weight percent. The Tyndall sand was pre-dried in an oven at 100° C. for 24 hours. To the pre-dried Tyndall sand was added 1 gram of water, which was then mixed for 1 minute. Then the binder containing the increased level of MPCP was added to the wet Tyndall aggregate, and further mixed for 2 to 4 minutes. The resulting mixture was added to a 2 inch height by 4 inch diameter cup, which had a silicone release liner, and work time (open time) was determined via a gel tester. After 24 hours, the specimen was removed from the cup.

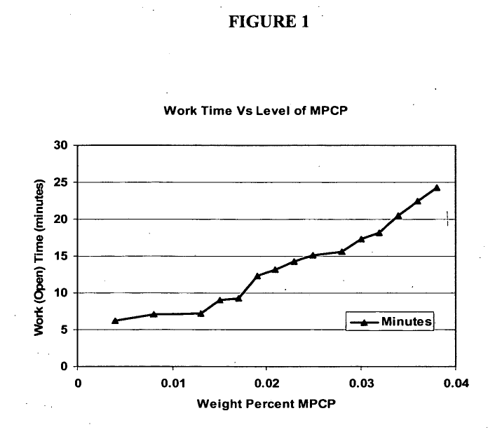

FIG. 1 graphically depicts the relationship between the addition of MPCP to the binder/aggregate mix and the work time observed. FIG. 1 shows that work time increases as the amount of MPCP increases.

### Example 2

Example 1 was repeated along with a control that did not contain MPCP. Both the work time and strip time were measured.

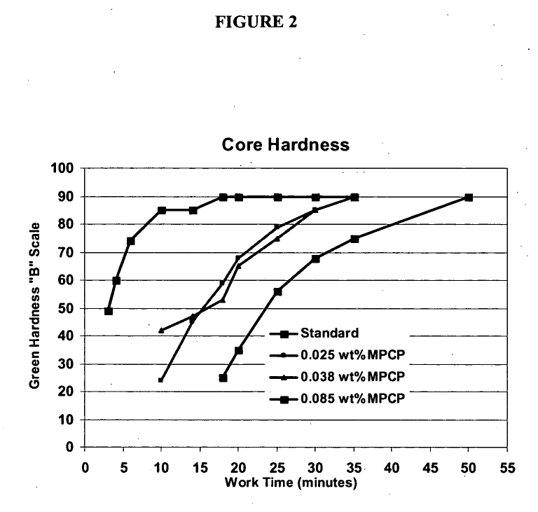

FIG. 2 graphically depicts the relationship between the addition of MPCP to the binder/aggregate mix and the work time observed. FIG. 2 shows that work time increases as the amount of MPCP increases and how long it takes before the shape becomes so hard that it cannot be removed from the pattern, i.e. when the green hardness reaches 90.

We claim:

1. A process for filling a space comprising:
adding a binder composition to said space, where said binder is packaged as one-part and said binder composition comprises a polyisocyanate pre-polymer containing free isocyanate groups, an effective catalytic amount of a divalent metal catalyst, and an effective retarding amount of an acid chloride retarder, under conditions where sufficient moisture is present to cure said binder composition after it has been added to said space.

2. The process of claim 1 wherein the acid chloride retarder is selected from the group consisting of is selected from the group consisting of benzoyl chloride, benzene phosphorus oxydichloride, phosphorus oxychloride, phthaloyl chloride, monophenyldichlorophosphate, and mixtures thereof.

3. The process of claim 2 wherein said pre-polymer is the reaction product of a polyol and a polyisocyanate.

4. The process of claim 3 wherein the content of free isocyanate groups in said pre-polymer is from 9 to 14 percent.

5. The process of claim 4 wherein the polyol is selected from the group consisting of polyester polyols, polyether polyols, phenolic resole resins, and mixtures thereof.

6. The process of claim 5 wherein the amount of acid chloride is from 0.01 to 0.3 weight percent based upon the weight of the binder.

7. The process of claim 6 wherein the moisture is present in the space to be filled or is added to the space to be filled prior to adding said space-filling composition.

8. The process of claim 7 wherein said binder composition further comprises an aggregate.

9. The process of claim 7 wherein said space to be filled contains an aggregate.

10. The process of claim 8 wherein the divalent metal catalyst is dibutyltindilaurate.

11. The process of claim 9 wherein the divalent metal catalyst is dibutyltindilaurate.

12. The process of claim 11 wherein the aggregate is selected from the group consisting of sand, crushed concrete, pea gravel, and rock.

13. The process of claim 10 wherein the amount of divalent metal catalyst is from 0.2 to 0.6 parts by weight based upon the parts by weight of the polyisocyanate pre-polymer.

14. The process of claim 11 wherein the amount of aggregate is from 50 to 95 parts by weight based upon 100 parts by weight of said binder.

15. The process of claim 12 wherein space to be filled is an opening in an airport runway.

16. The process of claim 1, 2, 3, 4, 5, 6, 7, 8, 9, 10, 11, 12, 13, 14, or 15 wherein polyisocyanate pre-polymer the also contains a catalytically effective amount of a tertiary amine catalyst.

17. The process of claim 14 wherein the binder composition is solvent-free.

18. The process of claim 15 wherein the tertiary amine is selected from the group consisting of 2,2′-dimorpholinodiethylether and N,N′-dimethylpiperazine.
